(19) United States
(12) Patent Application Publication
(10) Pub. No.: US 2017/0206487 A1
(43) Pub. Date: Jul. 20, 2017

(54) DRIVER DATA ANALYSIS

(71) Applicant: J. J. Keller & Associates, Inc., Neenah, WI (US)

(72) Inventors: Kari Lynn Gloudemans, Menasha, WI (US); Kari Ann DuBois, Menasha, WI (US); Ryan Robert Boynton, Oshkosh, WI (US); Jeffrey Allen Gonnering, Neenah, WI (US); Nathan Howard Owen, Kaukauna, WI (US)

(21) Appl. No.: 14/995,569

(22) Filed: Jan. 14, 2016

(51) Int. Cl. G06Q 10/06; G06Q 50/30

(52) U.S. Cl. CPC G06Q 10/063114; G06Q 50/30

(57) ABSTRACT

A method of analyzing driver data for a client, including receiving and centralizing a client's driver data from at least two sources of electronic logging devices providers to create a collective data source. The method further includes analyzing the data in the collective data source to determine an assessment, and outputting the assessment to the client, where the assessment represents a combined assessment of the data from the at least two sources.

### BACKGROUND

Embodiments of the invention relate to analyzing driver data, and particularly, analyzing driver data from multiple sources for a client, such as a trucking company with vehicles and a group of drivers to oversee.

The U.S. government requires drivers of trucks and other commercial vehicles to record information about their driving. For example, truck drivers must record changes in duty status. The driver information is used to determine whether drivers are meeting regulations and compliance standards. In recent times, there has been an increase in drivers recording their information electronically, particularly due to new regulations. One of the primary mechanisms for recording driver information is an electronic logging device (ELD). Other data logging systems including paper logging systems and Internet-based time record/logging systems are still in use.

### SUMMARY

One embodiment provides a method of analyzing driver data for a client. Among other things, the method includes receiving and centralizing a driver data from at least two electronic logging devices providers to create a collective data source. The method further includes analyzing the data from the collective data source using an electronic processor to determine an assessment of the driver data, and outputting the assessment to a device for viewing by the client. In one example, the assessment represents a combined assessment of the data from the at least two sources.

Another embodiment provides a method of analyzing driver data. Among other things, the method includes receiving and centralizing a client's driver data collected from at least two data forms or modalities from the group consisting of an electronic logging device, a paper logging system, and an Internet-based logging system to create a collective data source. The method further includes analyzing the data from the collective data source with an electronic processor to create an assessment, and outputting the assessment to the client. In one example, the assessment represents a combined assessment of the data from the at least two sources.

Yet another embodiment provides a method of analyzing driver data to determine behavior issues. The method includes, among other things, receiving and centralizing a driver data, analyzing the driver data in the collective data source using a calculation engine, analyzing the data from the calculation engine using a human client service specialist to determine driver behavior issues, and outputting to the client the analysis from both the calculation engine and the specialist.

Other aspects of the invention will become apparent by consideration of the detailed description and accompanying drawings.

### BRIEF DESCRIPTION OF THE DRAWINGS

FIG. 1 is a schematic diagram of a system of analyzing driver data according to one embodiment.

FIG. 2A-2C are examples a portable device displaying a graphical user interface generated by an application for tracking driver data.

FIG. 3 is a block diagram of an electronic logging device according to one embodiment.

FIG. 4 is block diagram of a remote computer in communication with at least one electronic logging device.

FIG. 5 is an example of an assessment output as it is displayed on a graphical user interface.

FIG. 6 is a flow chart of one embodiment of a method of analyzing driver data for a client.

FIG. 7 is a flow chart of another embodiment of a method of analyzing driver data for a client.

FIG. 8 is a flow chart of another embodiment of a method of analyzing driver data for a client.

### DETAILED DESCRIPTION

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items.

The government and the trucking industry require its drivers to record information about changes in duty status. Duty status includes accounts for a driver's total time driving and resting. This data is used to identify compliance issues. One of the main items drivers are required to record is hours of service. The trucking industry is moving away from paper logging systems to ELDs. The use of ELDs enables trucking companies to have real-time information on their drivers and has the potential to provide a more robust understanding of problematic areas. While this transition from paper logging systems to electronic logging systems has simplified the process of gathering driver data, it has also brought with it additional complications. For example, in some cases a trucking company may have data from both paper logging systems and electronic systems that must be accounted for in addressing compliance issues. Alternatively, a company may have to collect data from multiple ELDs from multiple sources and reconcile the information from the multiple sources.

The complexity of being in compliance with regulations, rules, and standards has changed because of the large volume of data coming from ELDs. Many compliance professionals working in the trucking industry have become overwhelmed with data. This causes some professionals to focus only on the simple, easily found issues and ignore the more complicated issues that are difficult to extrapolate from the large amounts of data being tracked from multiple sources. Compliance professionals can become overwhelmed when driver data is tracked through multiple sources. The compliance professional analyzing the data must view data from the multiple sources independently, and attempt to glean an overall understanding without having a unified source of information. Additionally, the data generated from the ELDs is often in summary format and does not provide the compliance professional with a deeper understanding of the information.

Various embodiments provide, among other things, a system and method of analyzing driver data for a client with multiple drivers. More specifically, the system and method provide centralized monitoring, analysis, and reporting of driver compliance issues. Data from multiple providers (e.g., data collection companies) is brought together to provide a holistic view of the organization. Data forms or sources can include, for example paper logging systems, electronic logging systems, and internet logging systems. Driver behavior issues can also be captured in or using the certain embodiments to address other performance factors.

The driver data is collected, centralized, processed in a calculation engine, and analyzed. Once the analysis is complete, clients are provided with a collective data source containing all of the data and statistics from the multiple sources. Clients will then be able to view the data from the collective data providers. In addition, the method provides clients with insight and actionable guidance into the areas that are causing compliance issues and driver behavior deficiencies within the organization. Information provided to the client can be delivered in a variety of ways, such as scheduled (e.g., weekly or monthly) reports, summaries, alerts, website access, or by a human client service specialist. A client service specialist uses the analyzed data to assist in addressing the needs of the client and help them identify and respond to driver deficiencies and behavioral issues. A website can also be provided to allow the clients to view data, reports, and alerts. The website can be used to generate additional reports and can provide high level summaries and detailed information.

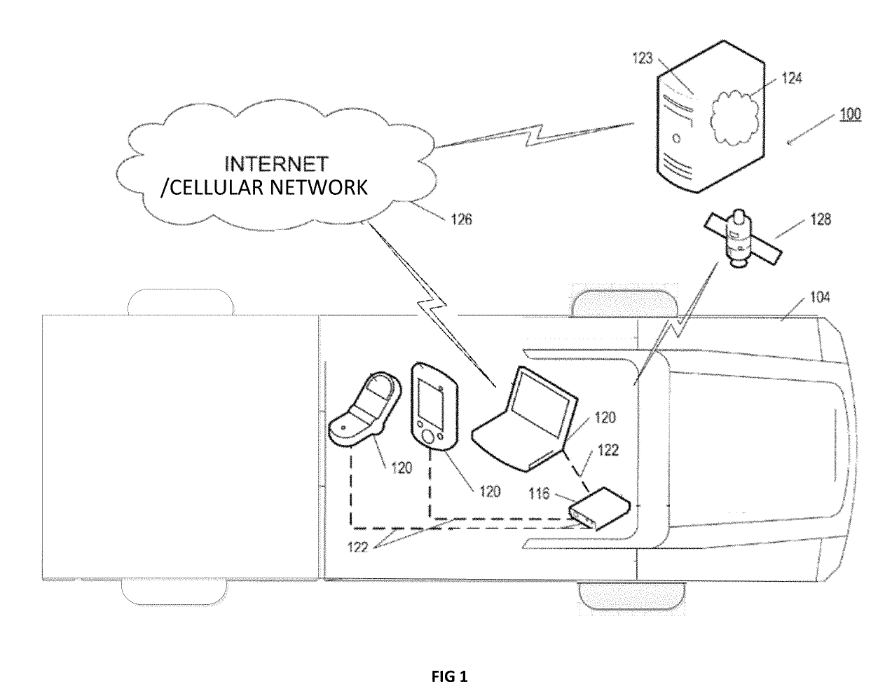

FIG. 1 is a schematic illustration of a system 100 of analyzing driver data for a client that manages multiple drivers. The system includes one or more ELD 116. In the embodiment shown, the ELD 116 is mounted or otherwise positioned in a vehicle 104. The vehicle 104 may be designed, for example, to transport goods. Although only one ELD 116 is depicted in FIG. 1, it will be understood by one skilled in the art that other ELDs 116 will be configured in a similar manner as the ELD 116 illustrated in FIG. 1. The ELD 116 tracks driver data and wirelessly transmits the data to a remote computer 123 via the internet and/or a cellular network (hereinafter “network”) 126. The remote computer 123 runs a host application 124 that functions as a calculation engine 125 to synthesize the data collected from the ELD 116 and centralizes that data with data from other ELDs 116 or from paper logs containing driver data. As will be explained in greater detail below, the centralized data can be analyzed, summarized, and reported to the client.

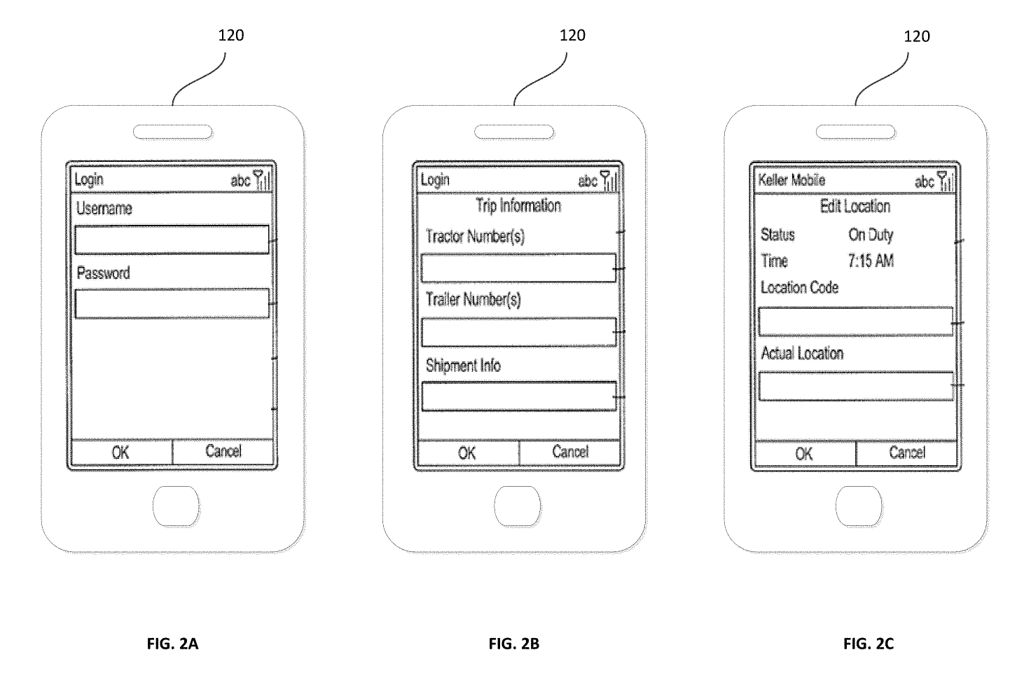

In some embodiments, the ELD 116 tracks driver data through the assistance of portable devices 120 such as a cellular phone, a tablet, or a computer. The ELD 116 communicates with the portable devices through a link 122. The link 122 may be a cable, such as a USB cable, or may be a wireless connection, such as a Bluetooth connection. With reference to FIGS. 2A-2C, the portable devices 120 include an application or program that enables drivers to log their information. For example, the application enables a driver to log in using a username and password (FIG. 2A), input their vehicle number and shipping information (FIG. 2B), and track their hours of service and location (FIG. 2C). Although FIGS. 2A-2C illustrate the application on a cellular phone, the application can be used with other types of portable devices 120.

In addition, the application can be incorporated directly onto the ELD 116 and can be displayed through a display unit 212 on the ELD 116. Referring back to FIG. 1, the illustrated ELD 116 is also in communication with a global position satellite (GPS) system 128. The GPS system 128 provides information regarding the time and location of the vehicle 104 (and by extension, the driver) to the ELD 116. Data collected from the GPS system 128 can help identify when a driver is in noncompliance with a company rule or government regulation. For example, the GPS system 128 can help a user identify when a driver has gone off the intended course or if a driver is still traveling beyond the allowed hours of service.

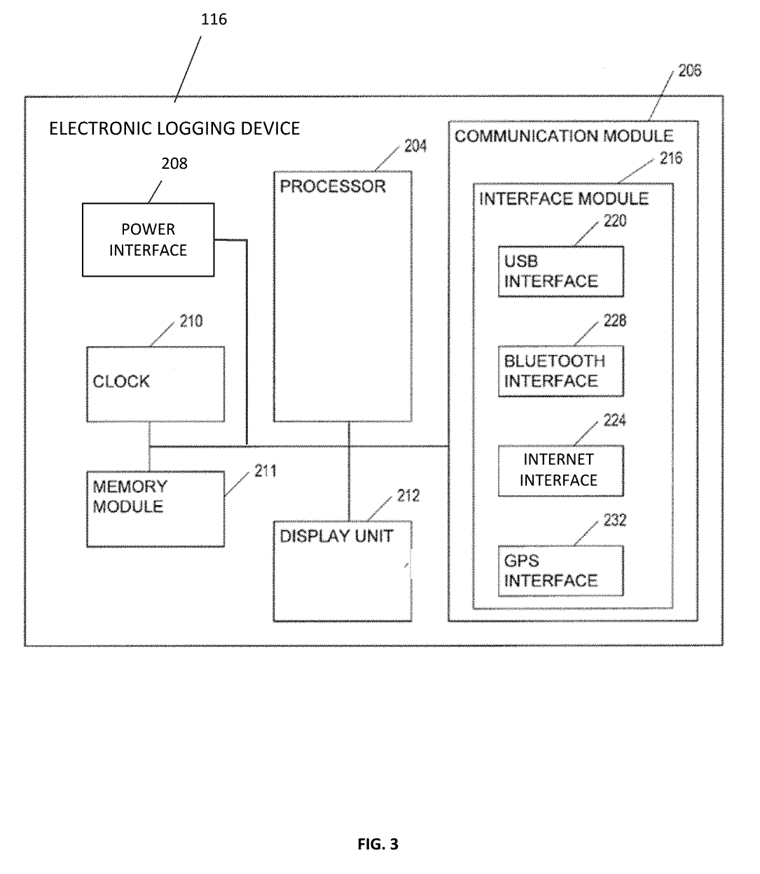

FIG. 3 depicts an example ELD 116 in a block diagram format. The illustrated ELD 116 includes a processor 204, a communication module 206, a power interface 208, a clock 210, a memory module 211, and the display unit 212. In other embodiments, the ELD 116 may not include all of these features. For example, in some embodiments, the ELD 116 does not include a clock 210 or a display unit 212. The communication module 206 includes an interface module 216 that includes a plurality of interfaces such as a USB interface 220, an internet/cellular network interface (hereinafter “internet interface”) 224, a Bluetooth interface 228, and a GPS interface 232. The USB interface 220 and the Bluetooth interface 228 are used to communicate with the portable devices 120. The GPS interface 232 is used to communicate with the GPS system 128. The internet interface 224 communicates with and transports data through the network 126.

Driver data is collected on the ELD 116 through multiple sources. For example, as mentioned, a user can input data into the application either on the portable device 120 or directly into the ELD 116. The ELD itself also includes a clock 210 and a power interface 208 that can track the amount of time the vehicle 104 is running. The GPS system 128 collects data on the timing and location of the driver and vehicle 104. Information collected by the multiple sources is collectively the “driver data.”

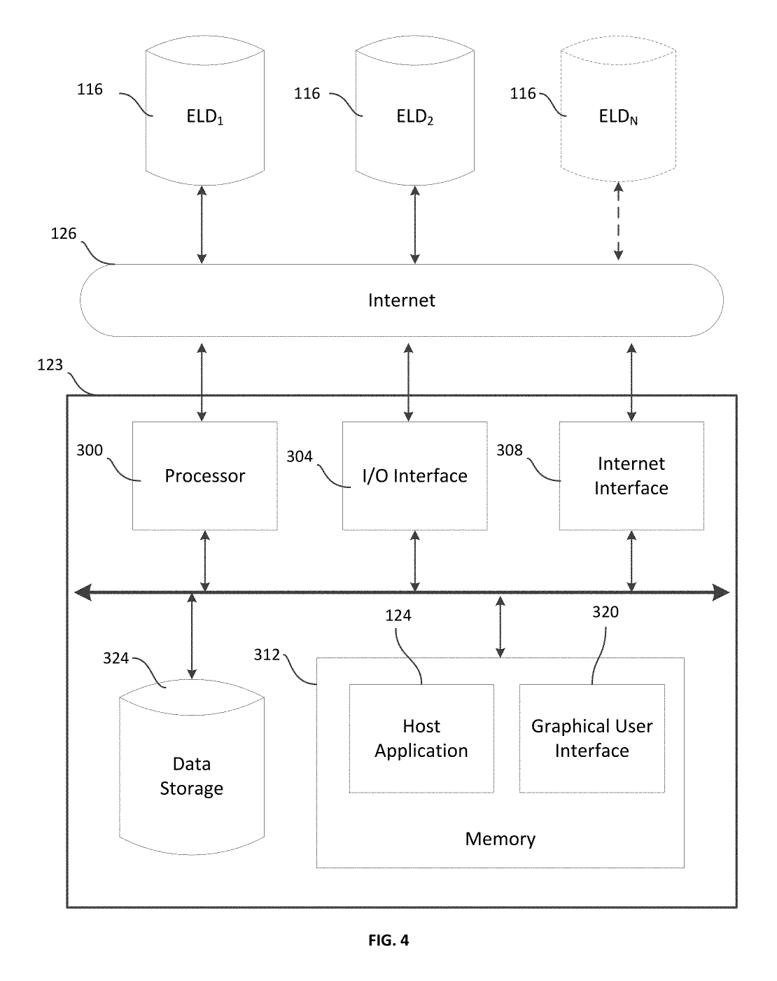

Driver data is collected from multiple ELDs 116 as well as paper logs (not shown) and internet based logs (not shown). Referring to FIG. 4, each ELD 116 transmits the driver data to the remote computer 123 through the network 126. The computer 123 includes an electronic processor 300, an input/output (I/O) interface 304, an internet interface 308, and a memory 312. Stored on the memory 312 is the host application 124, a graphical user interface (GUI) 320, and a collective data storage 324. The computer 123 receives the data from the multiple ELDs 116 and centralizes the data. The centralized data is stored on the collective data storage 324. In some embodiments, the processor 300 and the host application 124 work together as a calculation engine 125 to analyze the data. Specifically, the processor 330 and the host application 124 can centralize the driver data, identify trends in the driver data, determine whether any violations have occurred, create a driver score card, and produce reports and summaries of the driver data.

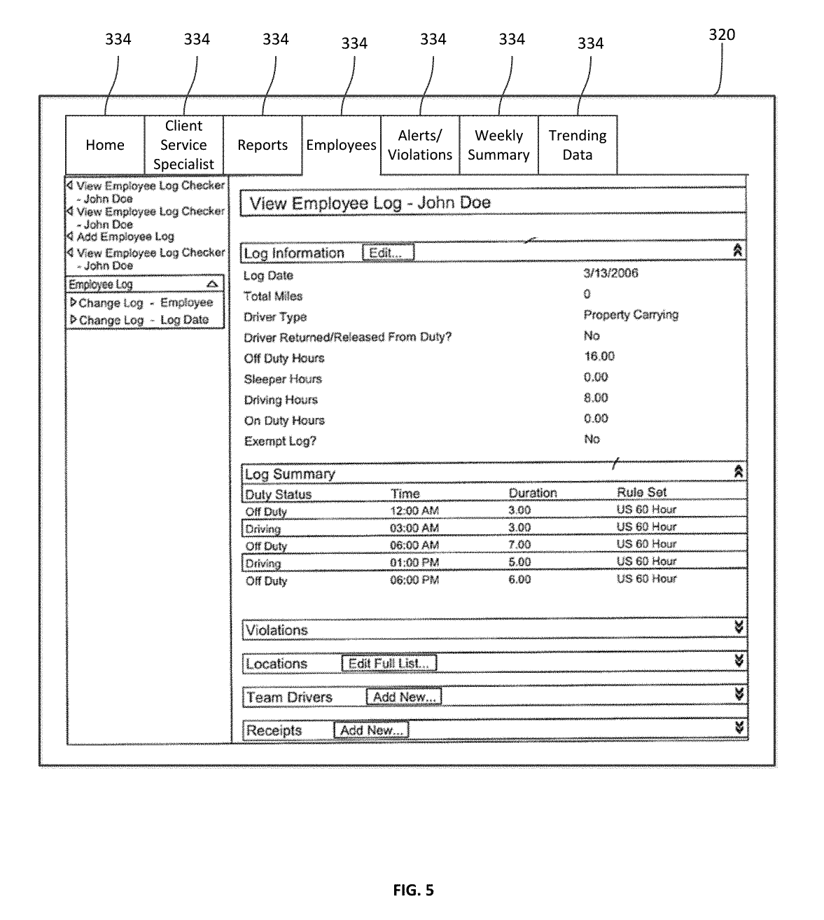

With reference to FIG. 5, the GUI 320 provides a user, such as a client, with information related to the driver data collected from the multiple ELDs 116. The information can be displayed on the GUI 320 according to the user's preferences and user can interact with the GUI 320 to analyze the driver data. FIG. 5 illustrates an example of how a GUI 320 could be designed; however, many options exist for displaying information on the GUI 320. The illustrated GUI 320 includes multiple tabs 334 such as an “Employee” tab 334 that shows the driver data and violations for each individual driver. A “Trending Data” tab 334 shows trends of driver behavior across all the drivers employed by the client. Likewise, a “Reports” tab 334 and a “Summary” tab 334 can display key information required by the client over a period of time specified by the client.

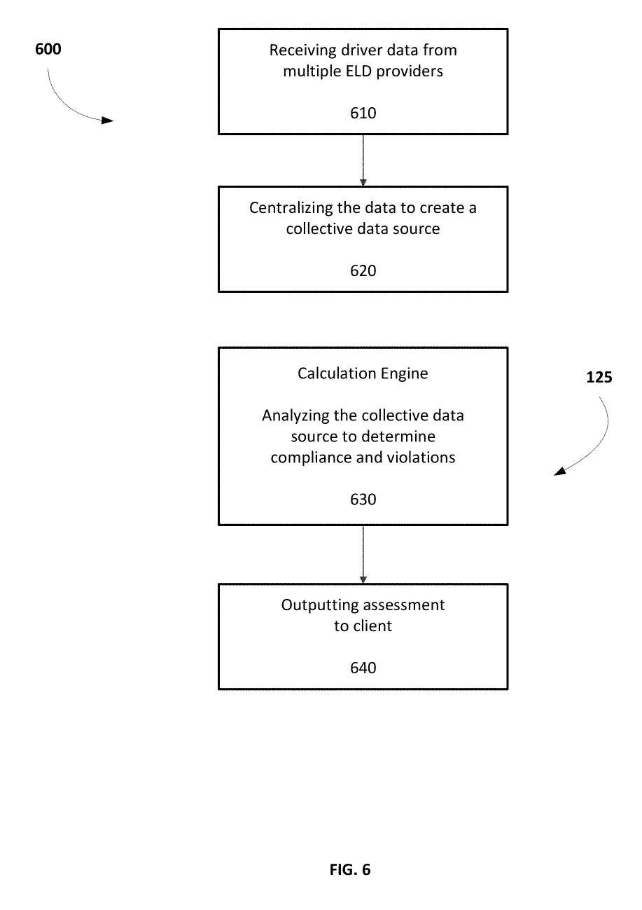

In operation, the system 100 provides a method of analyzing driver data for a client. FIG. 6 depicts a flow chart of a method 600 of analyzing driver data for a client. The clients are generally companies with vehicles such as trucks and a group of drivers to oversee. The client may have a particular employee in charge of managing or analyzing data logged by the drivers. For example, this employee may be compliance or regulatory specialist, a safety specialist, or a driver manager. A client's driver data is either collected by the company internally or through the use of data collection companies. Driver hours of service data can also be collected in the form of paper logs, where drivers are responsible for logging information about their changes in duty status. The collection companies provide the client with a system for the drivers to log this information. The driver data can be collected in multiple forms, such as ELDs 116, paper logs, or internet based logs.

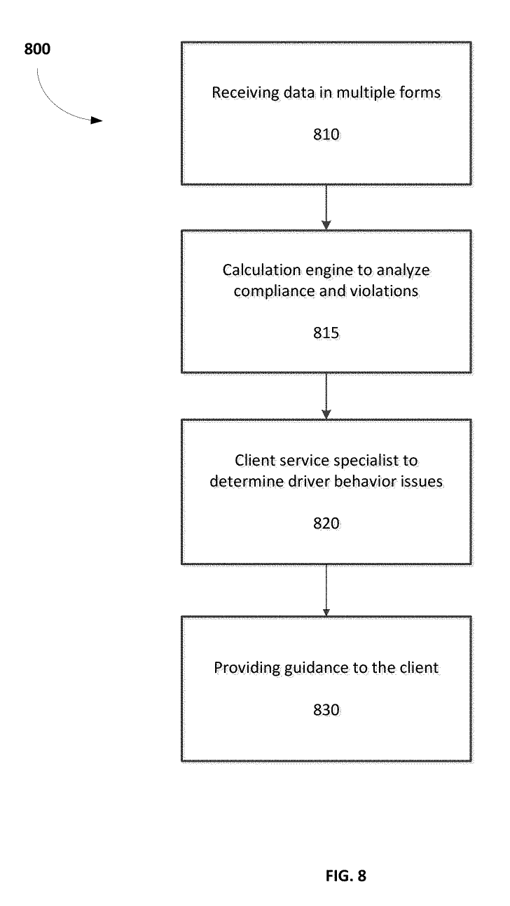

With continued reference to FIG. 6, the client's driver data is received (step 610) by the remote computer 123. The driver data may be sent from the client or directly from the data collection company. In the method according to FIG. 1, the data is sent from the ELDs 116 to the remote computer 123 electronically via the network 126. Driver data can also be received in different forms, such as paper logs and ELDs 116, and inputted or scanned as needed to digitize the data. In addition, the driver data can be collected from multiple data collection providers. For example, data collection company A may collect driver data for half of the client's drivers and collection company B may collect driver data for the second half of the client's drivers. The data would thus be collected from two separate providers, a first ELD 116 from collection company A and a second ELD 116 from collection company B. In the method illustrated in FIG. 8, driver data is received from at least two providers in the form of ELDs 116.

Once the driver data is received and collected on the remote computer 123, it is centralized to create a collective data source (step 620) that is stored on the collective data storage 324 space on the remote computer 123. The collective data source unifies the data from the multiple ELDs 116 so that data from the multiple providers can be viewed and analyzed as a single data source.

The data is then moved through a calculation engine 125 that parses the driver data to identify regulatory compliance issues and violations (step 630). The calculation engine 125 is preferably software programmed to input the driver data and determine compliance and violations data based on predetermined regulations and standards. In some embodiments the calculation engine 125 includes the processor 300 and the 124 application 316. The violations can include hours of service violations as determined by government regulations as well as other predetermined violations of interest to the client. Examples of such violations that can be identified by the calculation engine 125 include:

| Name | Violation Type |
|---|---|
| 14/15 Day Ruleset Change Violation | Critical |
| 24 Hours Off Duty in Prior 14 Days | Critical |
| 30 Minute Break Violation | Critical |
| Carrier Name and Address Missing/Incomplete | Critical |
| Cd Consecutive On Duty Violation | Critical |
| Cd Cycle Consecutive Off Duty Violation | Critical |
| Cd Daily Driving Violation | Critical |
| Cd Daily Off Duty Violation | Critical |
| Cd Daily On Duty Violation | Critical |
| Cd Deferred Day 1 Off Duty Violation (16a) | Critical |
| Cd Deferred Day 2 Off Duty Violation (16c) | Critical |
| Cd Start Time for Current 24 Hour Period Missing | Critical |
| Cd Total Off Duty Less than 20 Hours (16b) | Critical |
| Cd Two Day Driving Violation | Critical |
| Co-Driver Signature Missing/Incorrect | Critical |
| Falsified Log | Critical |
| Hours Driving Since Break | Critical |
| Hours On Duty in Work Week | Critical |
| Hours On Duty Since Break | Critical |
| Over 12 Hours Log Required | Critical |
| Over 14 Hours Log Required | Critical |
| Over 15 Hours Log Required | Critical |
| Total Distance Missing/Incomplete | Critical |
| Over Threshold Fuel Economy | Driver Behavior |
| Over Threshold Hard Braking | Driver Behavior |
| Over Threshold Idle Time | Driver Behavior |
| Over Threshold Speed Limit | Driver Behavior |
| Over Threshold Tachometer | Driver Behavior |
| Adverse Driving Condition Used | Form/Manner |
| Adverse Driving Condition Used Incorrectly | Form/Manner |
| Cd Beginning Odometer Missing | Form/Manner |
| Cd Cycle Change Invalid | Form/Manner |
| Cd Cycle Missing/Used Incorrectly | Form/Manner |
| Cd Deferred Days Missing/Used Incorrectly (82.1 g) | Form/Manner |
| Cd Driver Printed Name Missing/Incomplete | Form/Manner |
| Cd Ending Odometer Missing | Form/Manner |
| Cd Home Terminal Address Missing/Incomplete | Form/Manner |
| Driver Signature Missing/Incomplete | Form/Manner |
| Duty Status Change Remark Missing/Incomplete | Form/Manner |
| Multiple Logs For Same Day | Form/Manner |
| No Driving Hours for Miles | Form/Manner |
| No Miles for Driving Hours | Form/Manner |
| Shipment Info Missing/Incomplete | Form/Manner |
| Speed Over Max Average | Form/Manner |
| Team Driving Violation | Form/Manner |
| Total Hours Error | Form/Manner |
| Trucks/Tractors Missing/Incomplete | Form/Manner |
| Missing Log | Missing Log |

The calculation engine 125 can identify regulatory compliance issues as well as company specific compliance issues to ensure drivers are following company protocol. An assessment of regulatory compliance can provide not only a list of violations and problem areas, but can provide an explanation of the regulations and suggested solutions for addressing the violations. The company compliance assessment identifies when a driver violates company policies. For example, the company compliance assessment can identify when a driver is operating a unit he/she should not be driving, when a driver has wandered off of the route, or when a driver is using an empty company vehicle to driver to a personal destination. In addition, the assessment can identify errors in the logs such as missing logs and unassigned driving time, and driver behavior related to the use of the vehicle, such as hard braking, idle time, speed, fuel economy, engine speed, and seat belt use, depending upon the available data.

An assessment which includes the compliance and violations analysis is then outputted for review by the client (step 640). In the illustrated embodiment, the assessment is outputted to the client through the GUI 320, which is viewed, for example, through a website. The outputted assessment represents a combined assessment of the data from all of the driver data sources. Therefore, the outputted assessment provides a holistic examination of the driver data. The client has the option of using a custom built output or pre-built output. The output can be customized by the client so that the client receives the information in a manner they prefer. For example, a client may request for the output to include specific items or a list of violations. The outputted assessment can be provided to the client in a number of different forms. For example, the output may include a full report, a summary of violations, alerts or notifications, or predetermined (e.g. scheduled weekly or monthly) reports. The GUI 320 can have information available to a specific client according to its preferences. The client can view alerts of violations, trending data, extensive reports on the drivers, images of the logs, and a summary of problem areas. The GUI 320 also enables clients to run their own reports on the specific information they desire. In addition to the website, the output may be presented on a hard copy document, other communications formats or a combination thereof.

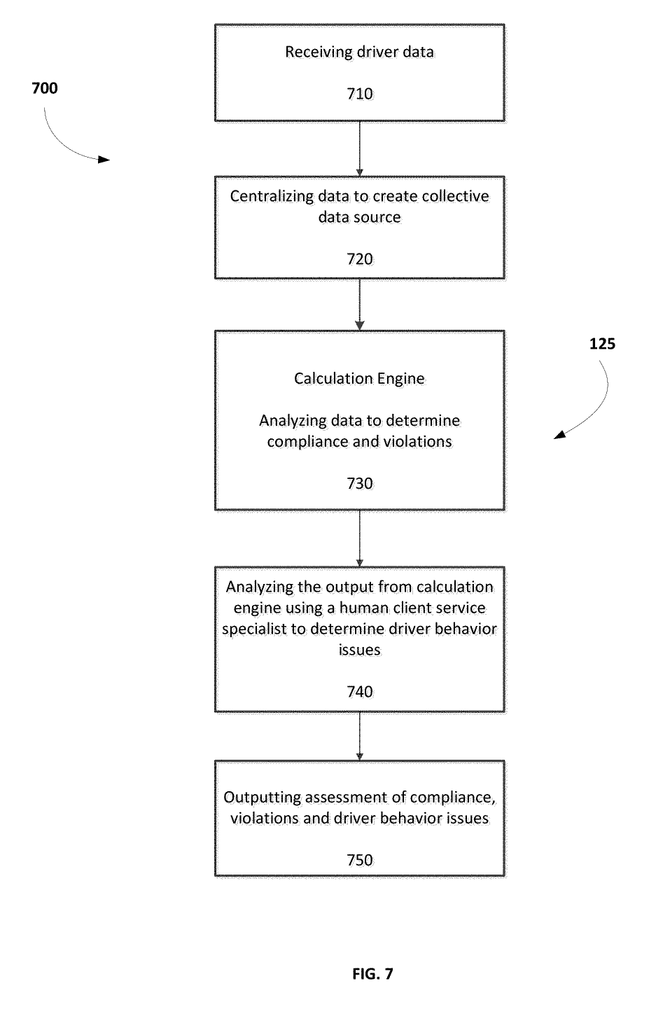

FIG. 7 illustrates a flow chart of another method 700 of analyzing driver data for a client. The data is received by the remote computer 123 (step 710) and centralized to create a collective data source (step 720). Once the collective data source is complete and saved in the collective data storage 324 space, the data is moved through a calculation engine 125 that parses the driver data to identify regulatory compliance issues and violations (step 730) such as was described above with respect to the embodiment in FIG. 8. In this embodiment, a human client service specialist accesses and analyzes the collective data and the output of the calculation engine 125 to determine driver behavior issues, problem areas and trends (step 740). Specifically, the client service specialist can perform the following tasks for example:
Communicate trending driver violation issues. Examples can include large number of drivers with a specific violation, a specific driver having a large number of violations all of a sudden, a location with a high number of violations, locations that are above/below average for the number of violations, and drivers who are above/below average for the number of violations.
Analysis as to what is causing a specific violation to be given and insight on how to correct it.
Guidance on what the violation means and how it relates to hours of service regulations.
Guidance on understanding why specific violations are occurring.
Insight on how to comply with the regulations in general.

A client service specialist can be assigned to each client to assist the client in understanding the driver data violations and behavior issues. The client service specialist can address the client's needs and assists the client in determining best practices and solutions to regulatory and company compliance issues and behavior issues. The client service specialist is person that is made available to contact with questions. This includes providing an explanation of the assessment, increasing the client's understanding of regulations, and resolving compliance and behavior issues. In some embodiments, the client service specialist is made available to the client through the use of a chat engine in the “Client Service Specialist” tab 334 on the GUI 320. In other embodiments, the client service specialist is available through other communication means, such as a video or audio conference provided on the “Client Service Specialist” tab 334.

The client service specialist helps the client understand compliance and driver behavior, identify areas that need improvement, and determine solutions to driver deficiencies and regulatory compliance issues. In particular, the specialist can identification driver behavior deficiencies, trends and can provide data and reports, regulatory guidance, driver score cards, and suggested solutions to address driver issues. The specialist can also provide the client with benchmarking information, suggested solutions to problem areas, areas needing improvement and insight into the prioritization needed to address driver behavior and compliance efforts.

The client service specialist can uncover issues from an individual driver standpoint, a corporate wide standpoint, or a locational standpoint. For example, a single driver's information can be analyzed to determine if there are concerns about a particular driver, or to determine if that particular driver is deficient such as using a driver scorecard. A driver score card is an assessment of an individual driver that examines the driver's performance and ranks the driver based on a set of predetermined criteria. The assessment can also provide information about a specific driver, including the driver's location, employee code, status, exemptions, violations, and the number of miles driven. Alternatively, driver data from all of the drivers managed by the client company can be analyzed as a whole to determine whether there are any company wide compliance issues. Similarly, drivers within each region can be analyzed separately to reveal whether a specific region is experiencing driver deficiencies or trends. Trend graphs can provide an at-a-glance view of how the client's drivers are performing within various locational regions or over a period of time.

Continuing to refer to FIG. 7, an assessment of the information from the calculation engine 125 and the client service specialist is outputted in an assessment to the client (step 750). The output can include any variety of forms as described above. The output can be generated through an Internet-based website, for example, and then supplemented by the assistance and insight of a client service specialist.

FIG. 8 illustrates another embodiment of a method 800 of analyzing driver data for a client. In this embodiment, data is received (step 810). The data can be from a single source but can be in multiple forms. For example, some data may be from one electronic logging device and some data from an internet based logging system. This will often include converting the two different forms of data into the same format before creating the collective data source. The calculation engine 125 parses the data to determine compliance and regulatory violations. The client service specialist analyzes the data to identify driver behavior issues (step 820). Guidance is provided to the client (step 830). Guidance can be provided in the form of a written report, via the client information website, or other forms such as email, text, telephone, or in person. The guidance can focus on areas in need of improvement, and will include suggested solutions and method of prioritizing the areas that need improvement. The guidance can be accompanied by a summary of the violations, information on driver trends, companywide deficiencies, trends over time, or other information

Although the invention has been described with reference to certain preferred embodiments, variations and modifications exit within the spirit and scope of the present invention. Various features and advantages of the invention are set forth in the following claims.

1. A method of analyzing driver data for a client, the method comprising:
receiving, by a remote computer, a client's driver data from at least two electronic logging devices providers;
centralizing, by a calculation engine, the driver data to create a collective data source;
analyzing, by the calculation engine, the data in the collective data source to determine an assessment of the driver data; and
outputting the assessment through a graphical user interface, the assessment representing a combined assessment of the data from the at least two sources.

2. The method of claim 1, wherein outputting to the client the assessment includes providing the client with an output in the form of at least one of a report, a notification, a website update, and a driver score card.

3. The method of claim 1, wherein outputting to the client further includes outputting at least a portion of the data in the collective data source.

4. The method of claim 1, wherein the assessment includes hours or service violations.

5. The method of claim 4, wherein the assessment includes client-defined violations.

6. The method of claim 1, wherein the calculation engine includes a processor and a host application.

7. The method of claim 1, further comprising the step of analyzing the data using a human client service specialist, wherein the human client service specialist is available to the user through the graphical user interface.

8. The method of claim 7, wherein the human service specialist identifies areas in need of improvement, and provides guidance to the client on prioritizing the areas in need of improvement.

9. The method of claim 7, wherein the human service specialist identifies driver behavior trends.

10. The method of claim 7, wherein the human service specialist provides guidance to the client to assist the client in meeting driver compliance standards.

11. The method of claim 1, further comprising storing the data on a collective data storage for an extended period beyond a six month time frame, and benchmarking the data in the collective data source over the extended period.

12. The method of claim 2, wherein the notification is one of a daily notification and a weekly notification to the client.

13. A method of analyzing driver data for a client, the method comprising:
receiving, by a remote computer, a client's driver data collected from at least two driver data forms from the following list: an electronic logging device, a paper logging system, and an internet logging system to create a collective data source;
centralizing the driver data by a calculation engine;
analyzing, by the calculation engine, the data in the collective data source to create an assessment; and
outputting the assessment to the client through a graphical user interface, the assessment representing a combined assessment of the data from the at least two sources.

14. The method of claim 13, wherein the output includes an assessment hours of service violations.

15. The method of claim 13, further including the step of providing a human client service specialist through the graphical user interface, wherein the specialist provides an explanation of the assessment to aid in the client's understanding of the client data in the collective data source, and wherein the specialist further provides guidance to assist the client in meeting driver compliance standards.

16. A method of analyzing driver data for a client, the method comprising:
receiving, by a remote computer, a client's driver data;
centralizing, by a calculation engine, the driver data to create a collective data source;
analyzing the data in the collective data source using the calculation engine;
analyzing the data from the calculation engine using a human client service specialist to determine driver behavior issues; and
outputting to the client the analysis from both the computerized system through a graphical user interface and the specialist.

17. The method of claim 16, wherein outputting to the client further includes providing the client with an output on the graphical user interface in the form of at least one of a report, a notification, a website update, and a driver score card.

18. The method of claim 16, wherein the computerized system assesses driver regulatory compliance and the specialist assesses driver behavior.

19. The method of claim 16, further comprising providing guidance to the client to improve at least one of driver deficiencies, driver violations, driver trends, and driver regulatory compliance issues.

20. The method of claim 16, further comprising providing guidance to the client to assist the client in meeting driver compliance standards, the guidance being provided by the specialist.

21. The method of claim 16 where the driver data is collected from at least two data sources from the following list: an electronic logging device, a paper logging system, and an internet logging system.
